(19) United States
(12) Patent Application Publication
(10) Pub. No.: US 2015/0129512 A1
(43) Pub. Date: May 14, 2015

(54) DISHWASHER APPLIANCE AND A METHOD FOR FILTERING LIQUID IN AN APPLIANCE

(71) Applicant: General Electric Company, Schenectady, NY (US)

(72) Inventor: Ramasamy Thiyagarajan, Louisville, KY (US)

(73) Assignee: General Electric Company, Schenectady, NY (US)

(21) Appl. No.: 14/075,348

(22) Filed: Nov. 8, 2013

(51) Int. Cl. B08B 3/14; C02F 1/00

(52) U.S. Cl. CPC B08B 3/14; C02F 1/001; C02F 2103/002
USPC 210/805; 210/767; 134/104.4

(57) ABSTRACT

A dishwasher appliance and a method for filtering liquid in an appliance are provided. The method includes directing a flow of unfiltered liquid over a filter medium of the appliance in a first direction and urging a flow of filtered liquid adjacent the filter medium of the appliance in a second direction. The first direction is substantially perpendicular to the second direction. Such cross flow can assist with limiting clogging of the filter medium.

### FIELD OF THE INVENTION

The present subject matter relates generally to methods for filtering liquid in appliances, such as dishwasher appliances.

### BACKGROUND OF THE INVENTION

During wash and rinse cycles, dishwashers typically circulate a fluid through a wash chamber over articles such as pots, pans, silverware, and other cooking utensils. The fluid can be e.g., various combinations of water and detergent during the wash cycle or water (which may include additives) during the rinse cycle. Typically the fluid is recirculated during a given cycle using a pump. Fluid is collected at or near the bottom of the wash chamber and pumped back into the chamber through e.g., nozzles in the spray arms and other openings that direct the fluid against the articles to be cleaned or rinsed.

Depending upon the level of soil upon the articles, fluids used during wash and rinse cycles will become contaminated with soils in the form of debris or particles that are carried with the fluid. In order to protect the pump and recirculate the fluid through the wash chamber, it is beneficial to filter the fluid so that relatively clean fluid is applied to the articles in the wash chamber and materials are removed or reduced from the fluid supplied to the pump.

For mechanical filtration, the selectivity of the filter to remove soil particles of different sizes is typically determined by providing fluid paths (such as pores or apertures) through filter media that are smaller than the particles for which filtration is desired. Particles having a dimension larger than the width of the fluid paths will be trapped or prevented from passing through the filter while particles smaller than the width of the fluid path will generally pass through. Some particle sizes and/or types may be not harmful to the pump or spray assemblies and, therefore, can be allowed to pass into the pump inlet. However, while some smaller particles may not be harmful to the pump, leaving such particles in the wash or rinse fluid may not be acceptable as these particles may become deposited on the articles being washed/rinsed and thereby affect the user's perception of the cleanliness and/or appearance.

While larger particles can generally be readily removed from the fluid circulated through the wash chamber, challenges are presented in removing smaller particles—particularly as the particle size targeted for removal decreases. For example, if a dishwashing appliance is provided with a fine particle filter—such as one for removing particles 200 microns or larger—the filter can be prone to clogging particularly during the early stages of the cleaning process. During a pre-wash cycle or early stage of a wash cycle, a greater amount of larger food particles may be present on the articles placed in the wash chamber. A fine particle filter—such as one for removing particles 200 microns are larger—may become substantially clogged.

To unclog the filter, a conventional approach has been to drain the dirty fluid from the wash chamber to remove the particles clogging the filter. New—i.e. clean fluid—is then reintroduced for cycling again. Depending on the level of soil still present on the articles, yet another cycle of draining and refilling may have to be repeated. Unfortunately, this run, drain, and refill approach for unclogging a filter is inefficient as it requires the use of additional fluid (i.e. water). Of course, a filter media can be selected that only captures larger particles so that it clogs less, such as e.g., 0.030″ or larger, but this comes at the expense of losing the ability to remove smaller particles from the fluid and an associated effect on the resulting cleanliness of the articles.

Another challenge with filtration of the wash fluid is servicing of the filter and, more particularly, the filter media. Sometimes, for example, food particles can become lodged in the filter requiring that the filter be removed and either manually cleaned or replaced. Certain conventional dishwashing appliances do not have a filter that is readily accessible to the user and/or otherwise readily cleanable or serviceable.

Accordingly, a dishwasher appliance having filtering system for the removal of particles from the wash fluid would be useful. More particularly, a dishwasher appliance having filtering system for the removal of particles from the wash fluid while that also includes features for limiting clogging of the filtering system would be useful.

### BRIEF DESCRIPTION OF THE INVENTION

The present subject matter provides a dishwasher appliance and a method for filtering liquid in an appliance. The method includes directing a flow of unfiltered liquid over a filter medium of the appliance in a first direction and urging a flow of filtered liquid adjacent the filter medium of the appliance in a second direction. The first direction is substantially perpendicular to the second direction. Such cross flow can assist with limiting clogging of the filter medium. Additional aspects and advantages of the invention will be set forth in part in the following description, or may be apparent from the description, or may be learned through practice of the invention.

In a first exemplary embodiment, a dishwasher appliance is provided. The dishwasher appliance includes a tub that defines a wash chamber. The tub has a sump positioned at a bottom portion of the tub. A filter assembly defines a filtered volume and an unfiltered volume. A filter medium of the filter assembly is disposed between the filtered volume and the unfiltered volume. The unfiltered volume has an entrance and an exit. The entrance of the unfiltered volume is in fluid communication with the sump of the tub such that the unfiltered volume is configured for receipt of liquid from the sump of the tub. The entrance and the exit of the unfiltered volume are positioned and oriented for directing liquid through the unfiltered volume in a first direction. The filtered volume also has an exit. The exit of the filtered volume is positioned and oriented for directing liquid out of the filtered volume in a second direction. The second direction is substantially perpendicular to the first direction.

In a second exemplary embodiment, a method for filtering liquid in an appliance is provided. The method includes directing a flow of unfiltered liquid over a filter medium of the appliance in a first direction and urging a flow of filtered liquid adjacent the filter medium of the appliance in a second direction. The first direction is substantially perpendicular to the second direction.

In a third exemplary embodiment, a dishwasher appliance is provided. The dishwasher appliance includes a tub that defines a wash chamber. The tub has a sump positioned at a bottom portion of the tub, a first pump, a second pump and a spray assembly positioned within the wash chamber of the tub. A filter assembly defines a filtered volume and an unfiltered volume. A filter medium of the filter assembly is disposed between the filtered volume and the unfiltered volume. The unfiltered volume has an entrance and an exit. The entrance of the unfiltered volume is in fluid communication with the sump of the tub such that the unfiltered volume is configured for receipt of liquid from the sump of the tub. The filtered volume also has an exit. An exit conduit extends from the exit of the unfiltered volume to the tub. The exit conduit is arranged for directing liquid from the unfiltered volume into the wash chamber of the tub. The first pump is operable to draw liquid through the unfiltered volume in a first direction into the exit conduit. A recirculation conduit extends from the exit of the filtered volume to the spray assembly. The recirculation conduit is arranged for directing liquid from the filtered volume to the spray assembly. The second pump is operable to draw liquid through the filtered volume in a second direction into the recirculation conduit. The second direction is different than the first direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of a dishwasher appliance according to an exemplary embodiment of the present subject matter.

FIG. 2 provides a side, section view of the exemplary dishwasher appliance of FIG. 1.

FIG. 3 provides a schematic view of a sump and a filter assembly according to an exemplary embodiment of the present subject matter.

FIG. 4 provides a perspective view of certain components of the exemplary filter assembly of FIG. 3.

FIGS. 5 and 6 provide perspective views of a filter assembly according to an exemplary embodiment of the present subject matter.

FIG. 7 provides an exploded view of the exemplary filter assembly of FIG. 5.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

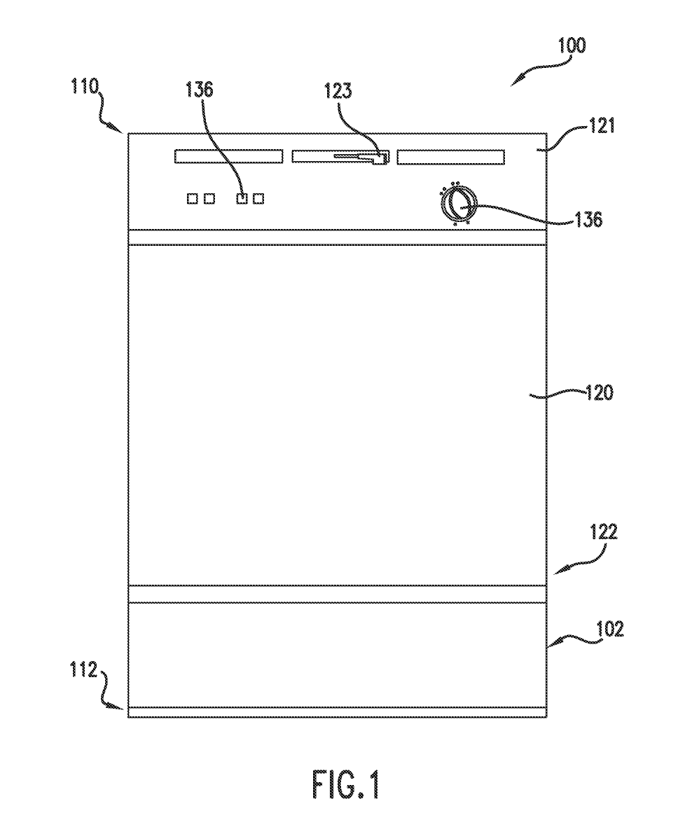

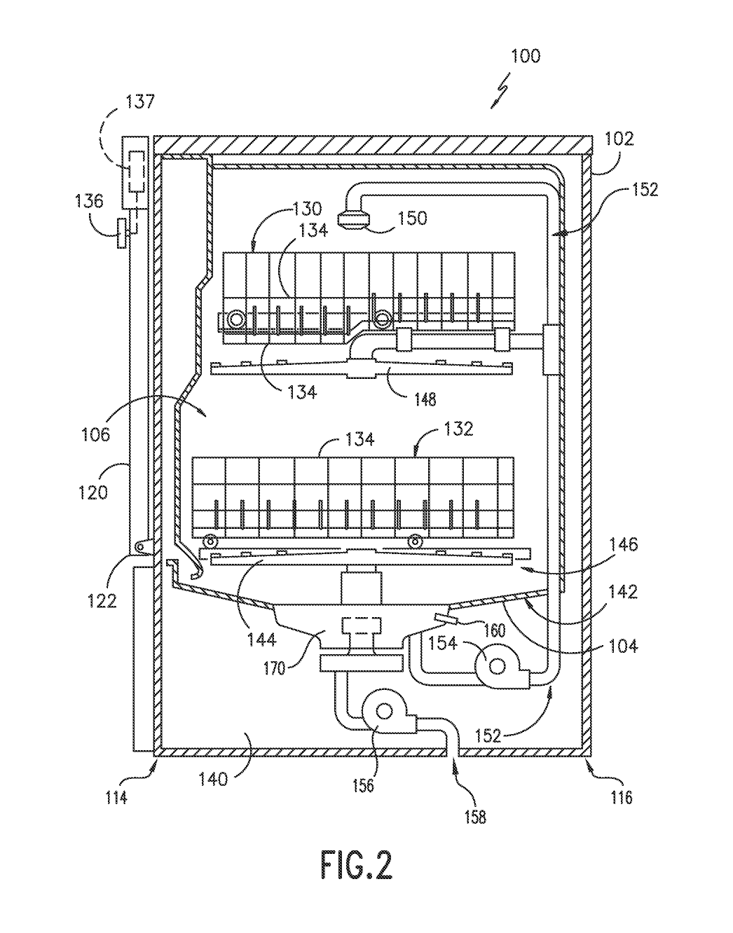

FIGS. 1 and 2 depict a dishwasher appliance 100 according to an exemplary embodiment of the present subject matter. As shown in FIG. 1, dishwasher appliance 100 includes a cabinet 102 that extends between a front portion 114 and a back portion 116. Cabinet 102 also extends between a top portion 110 and a bottom portion 112. Cabinet 102 has a tub 104 therein that defines a wash compartment 106. The tub 104 also defines a front opening (not shown). Dishwasher appliance 100 includes a door 120 hinged at a bottom 122 of door 120 for movement between a normally closed, vertical position (shown in FIGS. 1 and 2), wherein wash compartment 106 is sealed shut for washing operation, and a horizontal, open position for loading and unloading of articles from dishwasher appliance 100. Latch 123 is used to lock and unlock door 120 for access to wash compartment 106. Tub 104 also includes a sump assembly 170 positioned adjacent bottom portion 112 of cabinet 102 and configured for receipt of a liquid (e.g., water, detergent, wash fluid, and/or any other suitable fluid) during operation of dishwasher appliance 100.

A spout 160 is positioned adjacent sump assembly 170 of dishwasher appliance 100. Spout 160 is configured for directing liquid into sump assembly 170. Spout 160 may receive liquid from, e.g., a water supply (not shown) or any other suitable source. In alternative embodiments, spout 160 may be positioned at any suitable location within dishwasher appliance 100 such that spout 160 directs liquid into tub 104. Spout 160 may include a valve (not shown) such that liquid may be selectively directed into tub 104. Thus, for example, during the cycles described below, spout 160 may selectively direct water and/or wash fluid into sump assembly 170 as required by the current cycle of dishwasher appliance 100.

Rack assemblies 130 and 132 are slidably mounted within wash compartment 106. Each of the rack assemblies 130 and 132 is fabricated into lattice structures including a plurality of elongated members 134. Each rack of the rack assemblies 130 and 132 is adapted for movement between an extended loading position (not shown) in which the rack is substantially positioned outside the wash compartment 106, and a retracted position (shown in FIGS. 1 and 2) in which the rack is located inside the wash compartment 106. A silverware basket (not shown) may be removably attached to rack assembly 132 for placement of silverware, utensils, and the like, that are otherwise too small to be accommodated by the racks 130, 132.

Dishwasher appliance 100 further includes a lower spray assembly 144 that is rotatably mounted within a lower region 146 of the wash compartment 106 and above a tub sump portion 142 so as to rotate in relatively close proximity to rack assembly 132. A mid-level spray assembly 148 is located in an upper region of the wash compartment 106 and may be located in close proximity to upper rack 130. Additionally, an upper spray assembly 150 may be located above the upper rack 130.

The lower and mid-level spray assemblies 144, 148 and the upper spray assembly 150 are fed by a fluid circulation assembly 152 for circulating water and dishwasher fluid in the tub 104. Fluid circulation assembly 152 may include a recirculation pump 154 and a drain pump 156 located in a machinery compartment 140 located below tub sump portion 142 of the tub 104, as generally recognized in the art. Drain pump 156 is configured for urging wash fluid within sump assembly 170 out of tub 104 and dishwasher appliance 100 to a drain 158. Recirculation assembly 154 is configured for supplying a flow of wash fluid from sump assembly 170 to spray assemblies 144, 148 and 150.

Each spray assembly 144 and 148 includes an arrangement of discharge ports or orifices for directing wash fluid onto dishes or other articles located in rack assemblies 130 and 132. The arrangement of the discharge ports in spray assemblies 144 and 148 provides a rotational force by virtue of wash fluid flowing through the discharge ports. The resultant rotation of the lower spray assembly 144 provides coverage of dishes and other dishwasher contents with a spray of wash fluid.

Dishwasher appliance 100 is further equipped with a controller 137 to regulate operation of the dishwasher appliance 100. Controller 137 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 137 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 137 may be positioned in a variety of locations throughout dishwasher appliance 100. In the illustrated embodiment, controller 137 may be located within a control panel area 121 of door 120 as shown. In such an embodiment, input/output (“I/O”) signals may be routed between the control system and various operational components of dishwasher appliance 100 along wiring harnesses that may be routed through the bottom 122 of door 120. Typically, controller 137 includes a user interface panel 136 through which a user may select various operational features and modes and monitor progress of the dishwasher appliance 100. In one embodiment, user interface 136 may represent a general purpose I/O (“GPIO”) device or functional block. In one embodiment, user interface 136 may include input components, such as one or more of a variety of electrical, mechanical or electro-mechanical input devices including rotary dials, push buttons, and touch pads. User interface 136 may include a display component, such as a digital or analog display device designed to provide operational feedback to a user. User interface 136 may be in communication with controller 137 via one or more signal lines or shared communication busses.

It should be appreciated that the subject matter disclosed herein is not limited to any particular style, model, or other configuration of dishwasher, and that the embodiment depicted in FIGS. 1 and 2 is for illustrative purposes only. For example, instead of the racks 130, 132 depicted in FIG. 1, dishwasher appliance 100 may be of a known configuration that utilizes drawers that pull out from the cabinet and are accessible from the top for loading and unloading of articles.

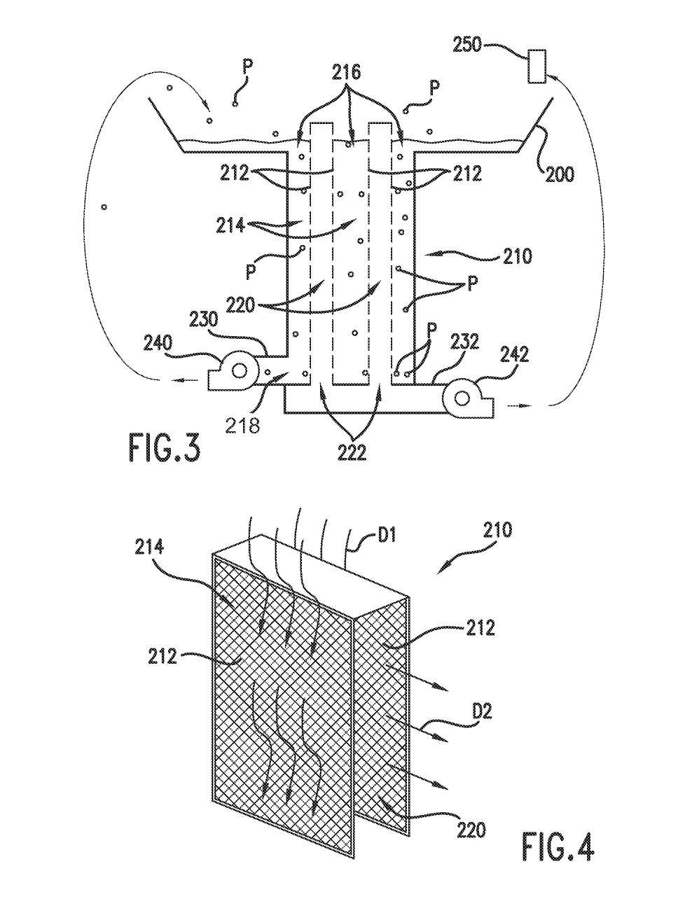

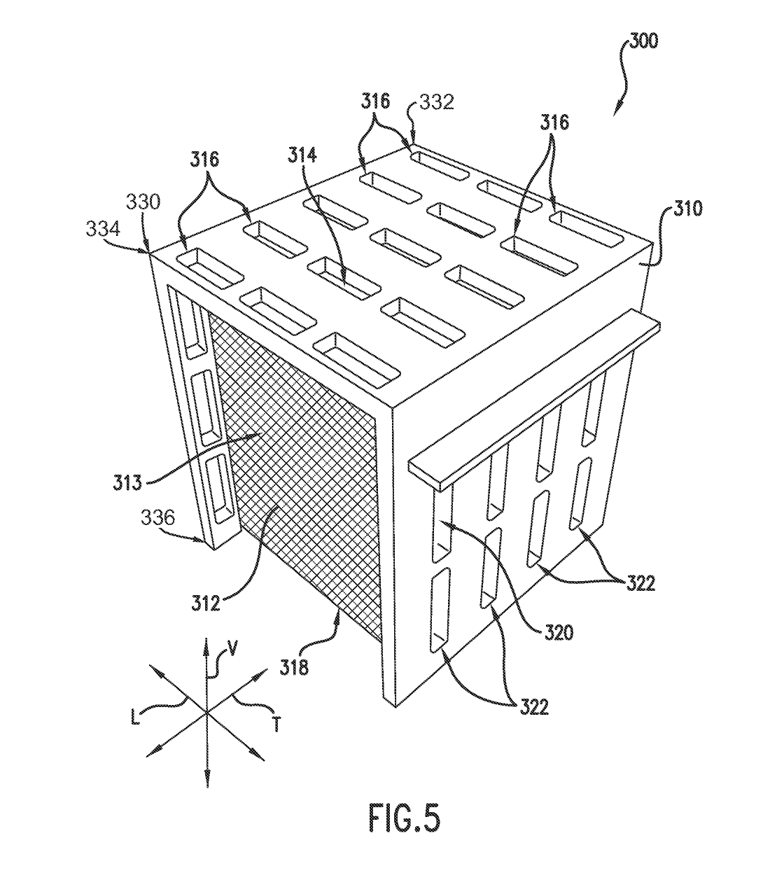

FIG. 3 provides a schematic view of a sump 200 and a filter assembly 210 according to an exemplary embodiment of the present subject matter. FIG. 4 provides a perspective view of certain components of filter assembly 210. Sump 200 and filter assembly 210 can be used in any suitable appliance. For example, sump 200 and filter assembly 210 may be used in dishwasher appliance 100 (FIG. 2), e.g., as sump assembly 170. In dishwasher appliance 100, filter assembly 210 can filter liquid passing therethrough and supply such filtered liquid to at least one of spray assemblies 144, 148 and 150. Filtering liquid supplied to spray assemblies 144, 148 and 150 can assist with limiting or preventing clogging of spray assemblies 144, 148 and 150.

As may be seen in FIGS. 3 and 4, filter assembly 210 includes filter media 212 and defines an unfiltered volume 214 and a filtered volume 220. Filter media 212 are disposed between filtered volume 220 and unfiltered volume 214. As used herein, the term “unfiltered” describes a volume that is not filtered relative to filter media 212 and the term “filtered” describes a volume that is filtered relative to filter media 212. However, as will be understood by those skilled in the art, filter assembly 210 may include additional filters that filter liquid entering unfiltered volume 214. Thus, unfiltered volume 214 may be filtered relative to other filters, such as a coarse filter, but not filter media 212. During operation filter assembly 210, filter media 212 are fixed or static.

Unfiltered volume 214 has at least one entrance 216 and at least one exit 218. Entrance 216 of unfiltered volume 214 is in fluid communication with sump 200. Thus, unfiltered volume 214 is configured for receipt of liquid from sump 200, and liquid in sump 200 flows into unfiltered volume 214 via entrance 216 of unfiltered volume 214. As discussed in greater detail below, liquid in unfiltered volume 214 passes or flows through filter media 212 into filtered volume 220. Filter media 212 removes debris or particles P from liquid passing through filtering media 212 from unfiltered volume 214 to filtered volume 220. Thus, unfiltered liquid passes though filter media 212 to remove debris or particles P and exits filter media 212 into filtered volume 220 as filtered liquid. Filtered volume 220 also includes an exit 222. Filtered liquid within filtered volume 220 then exits filtered volume 220 via exit 222 of filtered volume 220. In such a manner, unfiltered liquid follows a path through filter assembly 210. In particular, unfiltered liquid passes though filter media 212, and filtered liquid exits filter assembly 210. Such filtering can assist with limiting or preventing clogs in associated spray assemblies of an appliance.

Liquid in unfiltered volume 214 can also pass or flow out of unfiltered volume 214 via exit 218 of unfiltered volume 214. Thus, rather than flowing through filter media 212 into filtered volume 220 as described above, liquid in unfiltered volume 214 also passes or flows out of unfiltered volume 214 via exit 218 of unfiltered volume 214. The bypassed liquid flows back into sump 200 without being filtered by or with filter media 212. Thus, filter assembly 210 generates a cross flow across filter media 212 as shown in FIG. 4. Such cross flow can assist with limiting or preventing clogging or saturation of filter media 212 with debris or particles P.

Filter assembly 210 also includes a first pump 240, a second pump 242, an exit conduit 230 and a recirculation conduit 232. Exit conduit 230 extends from exit 218 of unfiltered volume 214 to first pump 240. First pump 240 is operable to draw liquid from unfiltered volume 214 to or towards first pump 240 via exit conduit 230. First pump 240 can be any suitable pump. For example, when used in dishwasher appliance 100 (FIG. 1), first pump 240 may be drain pump 156. Exit conduit 230 can also extend from exit 218 of unfiltered volume 214 to sump 200. Thus, exit conduit 230 can be arranged or configured for directing liquid from unfiltered volume 214 to sump 200, e.g., during operation of first pump 240. When used in dishwasher appliance 100, exit conduit 230 can be arranged or configured for directing liquid from unfiltered volume 214 to wash compartment 106 of tub 104, e.g., during operation of drain pump 156.

Recirculation conduit 232 extends from exit 222 of filtered volume 220 to second pump 242. Second pump 242 is operable to draw liquid from filtered volume 220 to or towards second pump 242 via recirculation conduit 232. Second pump 242 can be any suitable pump. For example, when used in dishwasher appliance 100 (FIG. 1), second pump 242 may be recirculation pump 154. Recirculation conduit 232 can also extend from exit 222 of filtered volume 220 to a spray assembly 250. Thus, recirculation conduit 232 can be arranged or configured for directing liquid from filtered volume 220 to the spray assembly 250, e.g., during operation of second pump 242. When used in dishwasher appliance 100, recirculation conduit 232 can be arranged or configured for directing liquid from filtered volume 220 to at least one of spray assemblies 144, 148 and 150, e.g., during operation of recirculation pump 154.

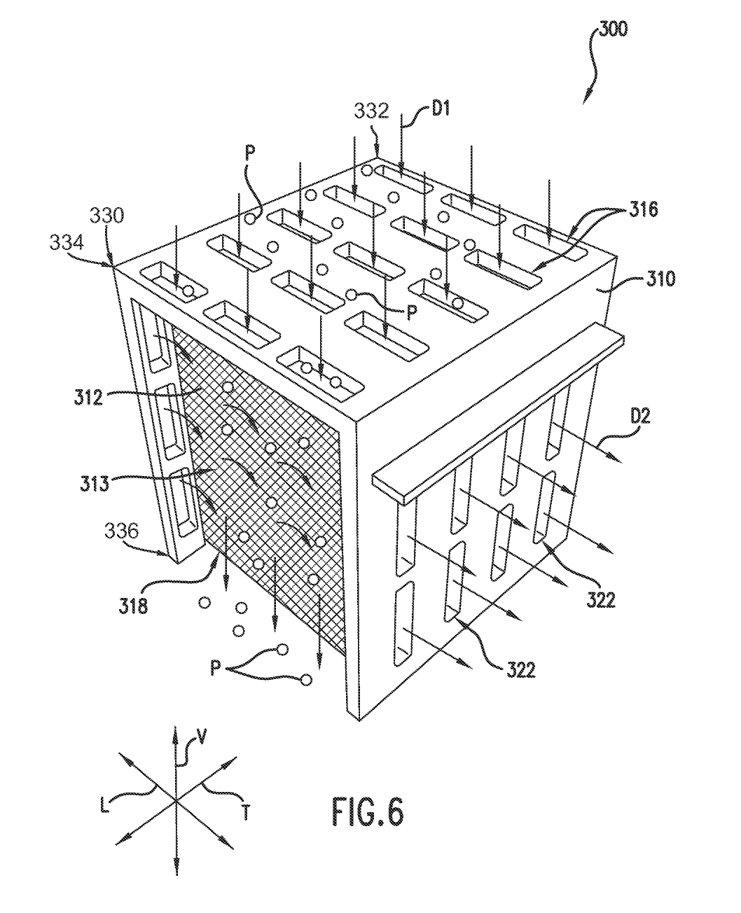

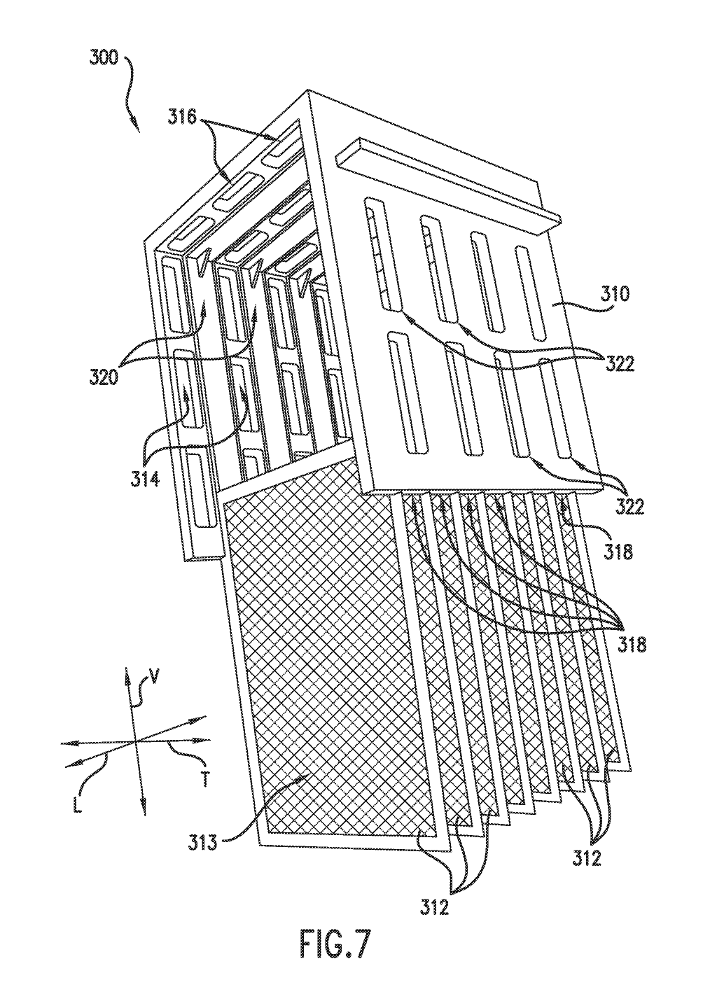

FIGS. 5 and 6 provide perspective views of a filter assembly 300 according to an exemplary embodiment of the present subject matter. FIG. 7 provides an exploded view of filter assembly 300. Filter assembly 300 can be used in any suitable appliance. For example, filter assembly 300 may be used in dishwasher appliance 100 (FIG. 2), e.g., as a component of sump assembly 170. In dishwasher appliance 100, filter assembly 300 can filter liquid passing therethrough and supply such filtered liquid to at least one of spray assemblies 144, 148 and 150. Filtering liquid supplied to spray assemblies 144, 148 and 150 can assist with limiting or preventing clogging of spray assemblies 144, 148 and 150. Filter assembly 210 (FIG. 3) can also be constructed and/or operate in a similar manner to filter assembly 300. Filter assembly 300 defines a vertical direction V, a lateral direction L and a transverse direction T. The vertical direction V, the lateral direction L and the transverse direction T are mutually perpendicular and form an orthogonal direction system.

Filter assembly 300 includes a main body 310 and filter media 312. Filter media 312 are, e.g., removably, mounted to main body 310. Within main body 310, filter media 312 assist with defining unfiltered volume 314 and a filtered volume 320. In particular, filter media 312 are disposed between an unfiltered volume 314 and a filtered volume 320. Unfiltered volume 314 has a plurality of entrances 316 and a plurality of exits 318. Entrances 316 of unfiltered volume 314 can be positioned or arranged for receipt of liquid, e.g., during operation of an associated appliance. Thus, unfiltered volume 314 is configured for receipt of unfiltered liquid, and such unfiltered liquid can flow into unfiltered volume 314 via entrance 316 of unfiltered volume 314.

Turning to FIG. 6, entrances 316 and exits 318 of unfiltered volume 314 are positioned and oriented for directing liquid through unfiltered volume 314 in a first direction (shown with arrows D1). For example, entrances 316 of unfiltered volume 314 may be positioned above exits 318 of unfiltered volume 314, e.g., along the vertical direction V. Thus, the first direction D1 can be substantially vertical, and liquid can flow through unfiltered volume 314 along the vertical direction V. In addition, main body 310 extends between a first side portion 330 and a second side portion 332, e.g., along the lateral direction L. Main body also extends between a top portion 334 and a bottom portion 336. Entrances 316 may be positioned at or adjacent top portion 334 of main body 310 and extend or be dispersed between first and second side portions 330 and 332 of main body 310, e.g., along the lateral direction L. Exits 318 may be positioned at or adjacent bottom portion 336 of main body 310 and extend or be dispersed between first and second side portions 330 and 332 of main body 310, e.g., along the lateral direction L.

As discussed in greater detail below, liquid in unfiltered volume 314 passes or flows through filter media 312 into filtered volume 320. Filter media 312 removes debris or particles P from liquid passing through filtering media 312 from unfiltered volume 314 to filtered volume 320. Thus, unfiltered liquid passes though filter media 312 to remove debris or particles P and exits filter media 312 into filtered volume 320 as filtered liquid. Filtered volume 320 also includes a plurality of exits 322. Filtered liquid within filtered volume 320 then flows out of filtered volume 320 via exits 322 of filtered volume 320.

Exits 322 of filtered volume 320 are positioned and oriented for directing liquid out of filtered volume 320 in a second direction (shown with arrows D2). For example, exits 322 of filtered volume 320 may be positioned between entrances 316 and exits 318 of unfiltered volume 314, e.g., along the vertical direction V. The second direction D2 can be substantially horizontal, and liquid can flow through unfiltered volume 314 along the lateral direction L or transverse direction T. Exits 322 of filtered volume 320 may be positioned at or adjacent second side portion 332 of main body 310 and extend or be dispersed between top and bottom portions 334 and 336 of main body 310, e.g., along the vertical direction V.

The second direction D2 is substantially perpendicular to the first direction D1. Both the first and second directions D1 and D2 can also be substantially parallel to an outer surface 313 of filter media 312. Thus, during operation of the associated appliance, a flow of unfiltered liquid within unfiltered volume 314 and adjacent filter media 312 is directed over or across filter media 312 in the first direction D1, and, in addition, a flow of filtered liquid within the filtered volume 320 and adjacent filter media 312 is urged in the second direction D2, e.g., over or across filter media 312.

The cross flow of liquid within unfiltered and filtered volumes 314 and 320 can assist with limiting or preventing clogging or saturation of filter media 312 with debris or particles P. The cross flow can also assist with flushing filter media 312 of debris or particles P and/or limiting collection of debris or particles P within filter media 312. Thus, simultaneously directing the flow of unfiltered liquid in the first direction Dl across filter media 312 and the flow of filtered liquid in the second direction D2 across filter media 312 can assist with limiting or preventing clogging or saturation of filter media 312 with debris or particles P and/or with flushing filter media 312 of debris or particles P.

To further assist with limiting or preventing clogging or saturation of filter media 312 with debris or particles P and/or with flushing filter media 312 of debris or particles P, the flow of unfiltered liquid in the first direction D1 can have a first velocity and the flow of filtered liquid in the second direction D2 can have a second velocity. The first and second velocities can be any suitable velocities. For example, the first velocity may be greater than the second velocity. As another example, a ratio of the first velocity to the second velocity may be greater than about two to one, greater than about four to one or greater than about five to one. When used in dishwasher appliance 100 (FIG. 1), controller 137 can be configured to operate drain pump 156 such that drain pump 156 draws the flow of unfiltered liquid in the first direction D1 at the first velocity and to work recirculation pump 154 such that recirculation pump 156 urges the flow of filtered liquid in the second direction D2 at the second velocity.

Filter media 312 can be any suitable filtering material or mechanism. For example, filter media 312 may be a plastic or metal mesh. In particular, filter media 312 can include a plurality of substantially flat or planar sheets that are spaced apart from each other, e.g., along the transverse direction T, as shown in FIG. 7. The filter media 312 can include any suitable number of substantially flat or planar sheets. For example, filter media 312 may include at least four substantially flat or planar sheets or at least eight substantially flat or planar sheets. By including multiple substantially flat or planar sheets, a filtering capacity of filter assembly 300 can be increased or improved relative to a single sheet.

Filter media 312 can be can be configured for fine filtration—e.g. filtering of relatively small particles. Accordingly, in one exemplary aspect of the present subject matter, filter media 312 may be configured (e.g., define holes or apertures) for removing particles in the size range of about fifty microns to about four hundred microns. For example, filter media 312 may be a screen or mesh having holes in the size range of about fifty microns to about four hundred microns. In another exemplary aspect of the present subject matter, filter media 312 may be configured (e.g., define holes or apertures) for removing particles in the size range of about three hundred microns to about six hundred microns. For example, filter media 312 may be a screen or mesh having holes in the size range of about three hundred microns to about six hundred microns. These size ranges are provided by way of example only. Other ranges may be used in certain exemplary embodiments of the present subject matter as well.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwasher appliance, comprising:
a tub defining a wash chamber, the tub having a sump positioned at a bottom portion of the tub;
a filter assembly defining a filtered volume and an unfiltered volume, a filter medium of the filter assembly disposed between the filtered volume and the unfiltered volume, the unfiltered volume having an entrance and an exit, the entrance of the unfiltered volume being in fluid communication with the sump of the tub such that the unfiltered volume is configured for receipt of liquid from the sump of the tub, the entrance and the exit of the unfiltered volume positioned and oriented for directing liquid through the unfiltered volume in a first direction, the filtered volume also having an exit, the exit of the filtered volume positioned and oriented for directing liquid out of the filtered volume in a second direction, the second direction being substantially perpendicular to the first direction.

2. The dishwasher appliance of claim 1, further comprising a first pump, a second pump, an exit conduit and a recirculation conduit, the exit conduit extending from the exit of the unfiltered volume to the first pump, the first pump operable to draw liquid from the unfiltered volume to the first pump via the exit conduit, the recirculation conduit extending from the exit of the filtered volume to the second pump, the second pump operable to draw liquid from the filtered volume to the second pump via the recirculation conduit.

3. The dishwasher appliance of claim 2, further comprising a controller in operative communication with the first and second pumps, the controller configured for
operating the first pump such that the first pump draws liquid though the unfiltered volume at a first velocity; and
working the second pump such that the second pump draws liquid through the filtered volume at a second velocity, the second velocity being less than the first velocity.

4. The dishwasher appliance of claim 3, wherein a ratio of the first velocity to the second velocity is greater than about four to one.

5. The dishwasher appliance of claim 1, wherein the entrance of the unfiltered volume is positioned above the exit of the unfiltered volume.

6. The dishwasher appliance of claim 5, wherein the exit of the filtered volume is positioned between the entrance and the exit of the unfiltered volume along a vertical direction.

7. The dishwasher appliance of claim 1, wherein the filter assembly comprises a plurality of filter media, the filter media of the plurality of filter media being laterally spaced apart from each other.

8. The dishwasher appliance of claim 7, wherein the plurality of filter media comprises at least four filter media.

9. The dishwasher appliance of claim 1, further comprising a spray assembly, an exit conduit and a recirculation conduit, the exit conduit extending from the exit of the unfiltered volume to the tub, the exit conduit arranged for directing liquid from the unfiltered volume to the wash chamber of the tub, the recirculation conduit extending from the exit of the filtered volume to the spray assembly, the recirculation conduit arranged for directing liquid from the filtered volume to the spray assembly, the spray assembly positioned within the wash chamber of the tub.

10. A method for filtering liquid in an appliance, comprising:
directing a flow of unfiltered liquid over a filter medium of the appliance in a first direction; and
urging a flow of filtered liquid adjacent the filter medium of the appliance in a second direction, the first direction being substantially perpendicular to the second direction.

11. The method of claim 10, wherein said step of directing comprises operating a first pump of the appliance in order to urge the flow of unfiltered liquid through a filter assembly of the appliance, wherein said step of urging comprises working a second pump of the appliance in order to draw the flow of filtered liquid from the filter assembly of the appliance.

12. The method of claim 10, wherein the flow of unfiltered liquid over the filter medium of the appliance has a first velocity during said step of directing, the flow of filtered liquid adjacent the filter medium of the appliance having a second velocity during said step of urging, the first velocity being greater than the second velocity.

13. The method of claim 12, wherein a ratio of the first velocity to the second velocity is greater than about four to one.

14. The method of claim 10, wherein said step of directing and said step of urging are conducted simultaneously.

15. The method of claim 10, further comprising:
returning the flow of unfiltered liquid to a wash chamber of the appliance; and
receiving the flow of filtered liquid at a spray assembly of the appliance.

16. The method of claim 10, wherein the first and second directions are substantially parallel to an outer surface of the filter medium.

17. The method of claim 10, wherein said step of directing comprises directing flows of unfiltered liquid over respective filter media of the appliance, the flows of unfiltered liquid flowing in the first direction during said step of directing, wherein said step of urging comprises urging flows of filtered liquid adjacent the respective filter media of the appliance, the flows of filtered liquid flowing in the second direction during said step of urging.

18. A dishwasher appliance, comprising:
a tub defining a wash chamber, the tub having a sump positioned at a bottom portion of the tub;
a first pump;
a second pump;
a spray assembly positioned within the wash chamber of the tub;
a filter assembly defining a filtered volume and an unfiltered volume, a filter medium of the filter assembly disposed between the filtered volume and the unfiltered volume, the unfiltered volume having an entrance and an exit, the entrance of the unfiltered volume being in fluid communication with the sump of the tub such that the unfiltered volume is configured for receipt of liquid from the sump of the tub, the filtered volume also having an exit;
an exit conduit extending from the exit of the unfiltered volume to the tub, the exit conduit arranged for directing liquid from the unfiltered volume into the wash chamber of the tub, the first pump operable to draw liquid through the unfiltered volume in a first direction into the exit conduit; and
a recirculation conduit extending from the exit of the filtered volume to the spray assembly, the recirculation conduit arranged for directing liquid from the filtered volume to the spray assembly, the second pump operable to draw liquid through the filtered volume in a second direction into the recirculation conduit, the second direction being different than the first direction.
